(19) United States
(12) Patent Application Publication
(10) Pub. No.: US 2020/0132489 A1
(43) Pub. Date: Apr. 30, 2020

(54) METHODS AND APPARATUS TO FACILITATE NAVIGATION USING A WINDSHIELD DISPLAY

(71) Applicant: Ford Global Technologies, LLC, Dearborn, MI (US)

(72) Inventors: Brandon DeMars, West Bloomfield, MI (US); Eduardo Fiore Barretto, Novi, MI (US); Erick Michael Lavoie, Dearborn, MI (US); Stephanie Rose Haley, Ann Arbor, MI (US)

(21) Appl. No.: 16/170,834

(22) Filed: Oct. 25, 2018

(51) Int. Cl. G01C 21/36; G02B 27/01; G01S 19/31

(52) U.S. Cl. CPC G01C 21/365; G01C 21/3664; G06T 3/20; G01S 19/31; G02B 27/0101

(57) ABSTRACT

Methods and apparatus are disclosed to facilitate navigation using a windshield display. An example vehicle comprises a global positioning system (GPS) receiver, a transceiver, and a processor and memory. The GPS receiver receives location data. The transceiver receives second party information. The processor and memory are in communication with the GPS receiver and the transceiver and are configured to determine a navigation option using the location data and the second party information and to dynamically display an image of the navigation option via a display.

### TECHNICAL FIELD

The present disclosure generally relates to automated vehicle features and, more specifically, methods and apparatus to facilitate navigation using a windshield display.

### BACKGROUND

In recent years, vehicles have been equipped with automated vehicle features such as turn-by-turn navigation announcements, parking assist, voice command telephone operation, etc. Automated vehicle features often make vehicles more enjoyable to drive and/or assist drivers in driving vigilantly. Information from automated vehicle features is often presented to a driver via an interface of a vehicle.

### SUMMARY

The appended claims define this application. The present disclosure summarizes aspects of the embodiments and should not be used to limit the claims. Other implementations are contemplated in accordance with the techniques described herein, as will be apparent to one having ordinary skill in the art upon examination of the following drawings and detailed description, and these implementations are intended to be within the scope of this application.

An example vehicle is disclosed. The example vehicle comprises a global positioning system (GPS) receiver, a transceiver, and a processor and memory. The GPS receiver receives location data. The transceiver receives second party information. The processor and memory are in communication with the GPS receiver and the transceiver and are configured to determine a navigation option using the location data and the second party information and to dynamically display an image of the navigation option via a display.

An example method is disclosed. The method comprises: determining, with a processor, a navigation option for a driver of a vehicle using location data received via a global positioning system receiver and second party information received via a transceiver; and dynamically displaying an image of the navigation option via a display.

An example system is disclosed. The system comprises: a network, a mobile device, a central facility, and a vehicle. The mobile device is in communication with the network. The central facility is in communication with the network. The vehicle comprises a transceiver, a global positioning system (GPS) receiver, an infotainment head unit (IHU), and a processor and memory. The transceiver is in communication with the network to receive second party information from one or more of the mobile device and the central facility. The global positioning system (GPS) receiver is in communication with a GPS satellite to generate location data. The processor and memory are in communication with the transceiver, the GPS receiver, and the IHU and are configured to determine a navigation option using the location data and the second party information and to dynamically display an image of the navigation option via the IHU.

### BRIEF DESCRIPTION OF THE DRAWINGS

For a better understanding of the invention, reference may be made to embodiments shown in the following drawings. The components in the drawings are not necessarily to scale and related elements may be omitted, or in some instances proportions may have been exaggerated, so as to emphasize and clearly illustrate the novel features described herein. In addition, system components can be variously arranged, as known in the art. Further, in the drawings, like reference numerals designate corresponding parts throughout the several views.

FIG. 1 is a side schematic view of a vehicle operating in accordance with the teachings of this disclosure in an environment.

FIG. 2 is a top schematic view of the vehicle of FIG. 1.

FIG. 3 is a block diagram of the electronic components of the vehicle of FIG. 1.

FIG. 4 is a more detailed block diagram of the guidance analyzer of FIG. 5.

FIG. 5A illustrates a look-up table stored in a memory of the electronic components of FIG. 3.

FIG. 5B illustrates another look-up table stored in the memory of the electronic components of FIG. 3.

FIG. 5C illustrates another look-up table stored in the memory of the electronic components of FIG. 3.

FIG. 6 is a schematic view of the heads-up display (HUD) of the vehicle of FIG. 1.

FIG. 7 is another schematic view of the HUD of the vehicle of FIG. 1.

FIG. 8 is another schematic view of the HUD of the vehicle of FIG. 1.

FIG. 9 is another schematic view of the HUD of the vehicle of FIG. 1.

FIG. 10 is a flowchart of a method to display navigation options to a driver of vehicle of FIGS. 1-2, which may be implemented by the electronic components of FIG. 3.

### DETAILED DESCRIPTION OF EXAMPLE EMBODIMENTS

While the invention may be embodied in various forms, there are shown in the drawings, and will hereinafter be described, some exemplary and non-limiting embodiments, with the understanding that the present disclosure is to be considered an exemplification of the invention and is not intended to limit the invention to the specific embodiments illustrated.

Automated vehicle navigation features include turn-by-turn directions, parking assist, and voice commands, among others. Turn-by-turn directions determine a route from a vehicle's current location to a destination and provide instructions for a driver to follow. Theses instructions are written messages presented via a display and/or audible messages announced via speakers (e.g., pre-recorded announcements). Parking assist determines locates available parking spots, determines whether the vehicle will fit in the parking spot, and controls the vehicle's steering to maneuver into the parking spot. Voice commands are used to control a paired telephone, control the vehicle's climate settings, and sound system, among others.

In recent years, vehicle interfaces have become more complex. Additionally, peripheral technologies (e.g., smartphones, media players, etc.) are more frequently used in vehicles and their interfaces have also become more complex. In some instances, drivers may use interfaces (e.g., buttons, touchscreens, etc.) of the vehicle and interfaces of the peripheral technologies in concert.

This disclosure provides methods and apparatus to facilitate navigation using a windshield display. By using a windshield display, drivers may be presented with navigation options, shown available parking spots, a given guidance recommendations, without taking their eyes from the road.

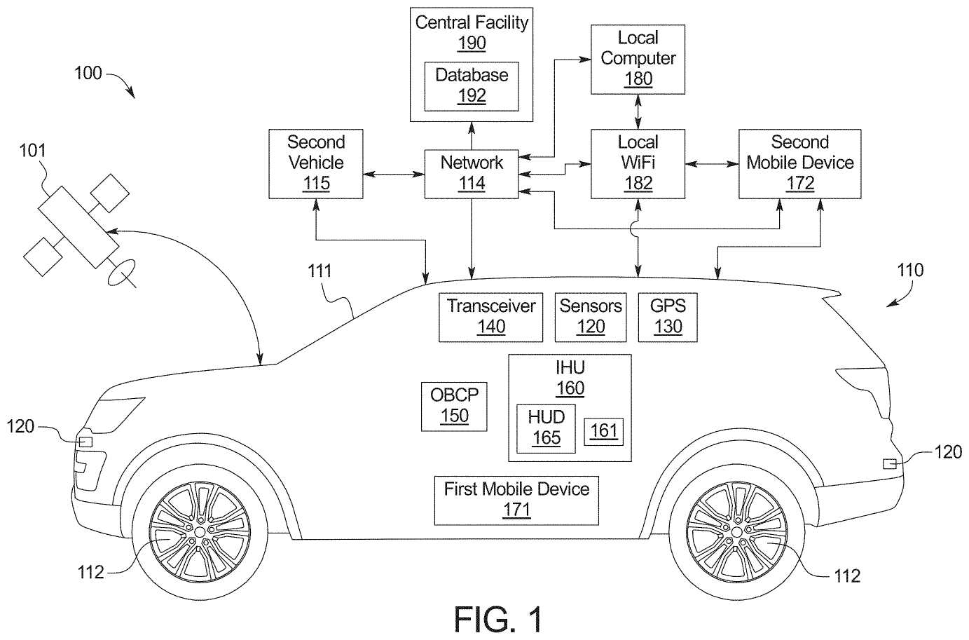

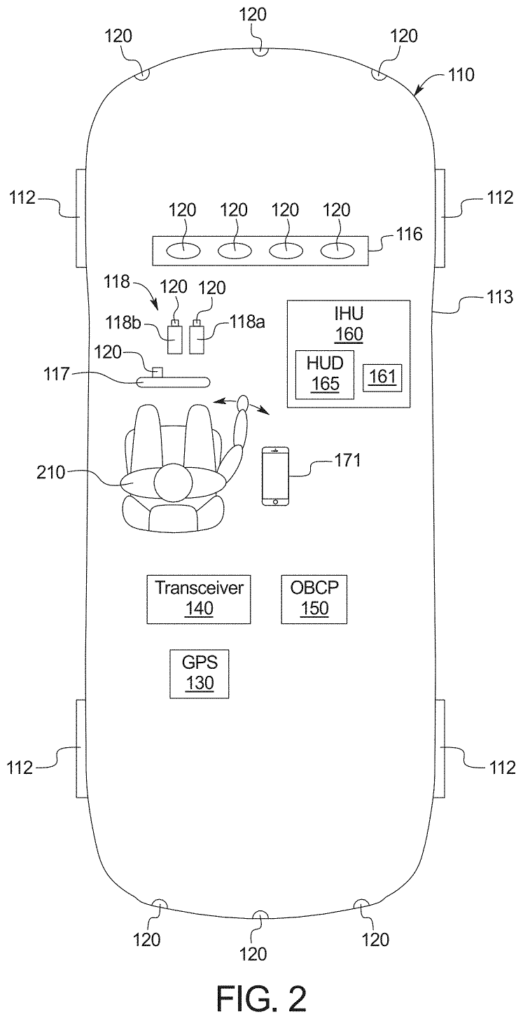

FIG. 1 is a side schematic view of a vehicle 110 operating in accordance with the teachings of this disclosure in an environment 100. FIG. 2 is a top schematic view of the vehicle 110.

As shown in FIG. 1, the environment 100 includes a global positioning system (GPS) satellite 101, a first vehicle 110, a network 114, a second vehicle 115, a first mobile device 171, a second mobile device 172, a local computer 180, a local area wireless network 182, and a central facility 190.

The first and second vehicles 110, 115, the first and second mobile devices 171, 172, the local computer 180, and the central facility 190 are in communication with one another via the network. In some instances, the local computer 180 is in communication with the network 114 via the local area wireless network 182. In some instances, the first vehicle 110 is in communication with the local computer 180 and the second mobile device 172 via the local area wireless network 182. In some instances, the first vehicle 110 is in direct communication with the second mobile device 172. In some instances, the first vehicle 110 is in direct communication with the second vehicle 115 (e.g., via V2X communication).

The vehicle 110 may be a standard gasoline powered vehicle, a hybrid vehicle, an electric vehicle, a fuel cell vehicle, and/or any other mobility implement type of vehicle. The vehicle 110 includes parts related to mobility, such as a powertrain with an engine, a transmission, a suspension, a driveshaft, and/or wheels, etc. The vehicle 110 may be non-autonomous, semi-autonomous (e.g., some routine motive functions controlled by the vehicle 110), or autonomous (e.g., motive functions are controlled by the vehicle 110 without direct driver input). As shown in FIGS. 1 and 2, the vehicle 110 includes a windshield 111, wheels 112, a body 113, a rear-view mirror 116, a steering wheel 117, a pedal assembly 118, sensors 120, a GPS receiver 130, a transceiver 140, an on board computing platform (OBCP) 150, an infotainment head unit (IHU) 160, and a heads-up display (HUD) 165. The pedal assembly 118 includes an accelerator pedal 118a and a brake pedal 118b. The first vehicle 110 is in communication with the GPS satellite 101 via the GPS receiver 130. It should be understood and appreciated that the second vehicle 115 includes some or all the features included in the first vehicle 110.

As shown in FIGS. 1 and 2, the first mobile device 171 is disposed in the vehicle 110.

The sensors 120 may be arranged in and around the vehicle 110 in any suitable fashion. The sensors 120 may be mounted to measure properties around the exterior of the vehicle 110. Additionally, some sensors 120 may be mounted inside the cabin of the vehicle 110 or in the body of the vehicle 110 (such as, the engine compartment, the wheel wells, etc.) to measure properties in the interior of the vehicle 110. For example, such sensors 120 may include accelerometers, odometers, tachometers, pitch and yaw sensors, wheel speed sensors, microphones, tire pressure sensors, and biometric sensors, etc. In the illustrated example, the sensors 120 are object-detecting sensors (e.g., ultrasonic, infrared radiation, cameras, time of flight infrared emission/reception, etc.) and position-detecting sensors (e.g., Hall effect, potentiometer, etc.). The sensors 120 are mounted to, included in, and/or embedded in the windshield 111, the body 113, the rear-view mirror 116, the steering wheel 117, and/or the pedal assembly 118. The sensors 120 detect objects (e.g., parked vehicles, buildings, curbs, etc.) outside the vehicle 110. The sensors 120 detect a steering angle of the steering wheel 117 and pedal positions of the accelerator and brake pedals 118a, 118b. The sensors 120 detect selection inputs made by the driver 210. More specifically, the sensors 120 detect gestures, touchscreen touches, and button pushes made by the driver 210. In other words, the sensors 120 generate surroundings information, selection information, and maneuvering information for the vehicle 110.

The example GPS receiver 130 includes circuitry to receive location data for the vehicle 110 from the GPS satellite 101. GPS data includes location coordinates (e.g., latitude and longitude).

The example transceiver 140 includes antenna(s), radio(s) and software to broadcast messages and to establish connections between the first vehicle 110, the second vehicle 115, the first mobile device 171, the second mobile device 172, the local computer 180, and the central facility 190 via the network 114. In some instances, the transceiver 140 is in direct wireless communication with one or more of the second vehicle 115, the first mobile device 171, and the second mobile device 172.

The network 114 includes infrastructure-based modules (e.g., antenna(s), radio(s), etc.), processors, wiring, and software to broadcast messages and to establish connections between the first vehicle 110, the second vehicle 115, the first mobile device 171, the second mobile device 172, the local computer 180, and the central facility 190.

The local area wireless network 182 includes infrastructure-based modules (e.g., antenna(s), radio(s), etc.), processors, wiring, and software to broadcast messages and to establish connections between the first vehicle 110, the local computer 180, and the second mobile device 172.

The OBCP 150 controls various subsystems of the vehicle 110. In some examples, the OBCP 150 controls power windows, power locks, an immobilizer system, and/or power mirrors, etc. In some examples, the OBCP 150 includes circuits to, for example, drive relays (e.g., to control wiper fluid, etc.), drive brushed direct current (DC) motors (e.g., to control power seats, power locks, power windows, wipers, etc.), drive stepper motors, and/or drive LEDs, etc. In some examples, the OBCP 150 processes information from the sensors 120 to execute and support automated vehicle navigation features. Using surroundings information, selection information, and maneuvering information provided by the sensors 120, the OBCP 150 detects driver behavior (e.g., highway driving, city driving, searching for a parking spot, etc.), determines targets (e.g., open parking spaces, a leading vehicle, a passenger waiting for pickup, etc.), determine options for the driver 210 (e.g., parking spaces large enough for the vehicle 110, routes to follow a leading vehicle, etc.), and generates images of the options for presentation to the driver 210.

The infotainment head unit 160 provides an interface between the vehicle 110 and a user. The infotainment head unit 160 includes digital and/or analog interfaces (e.g., input devices and output devices) to receive input from the user(s) and display information. The input devices may include, for example, a control knob, an instrument cluster, a digital camera for image capture and/or visual command recognition, a touch screen, an audio input device (e.g., cabin microphone), buttons, or a touchpad. The output devices may include instrument cluster outputs (e.g., dials, lighting devices), actuators, a center console display (e.g., a liquid crystal display (“LCD”), an organic light emitting diode (“OLED”) display, a flat panel display, a solid state display, etc.), an instrument cluster display, and/or speakers. In the illustrated example, the infotainment head unit 160 includes hardware (e.g., a processor or controller, memory, storage, etc.) and software (e.g., an operating system, etc.) for an infotainment system (such as SYNC® and MyFord Touch® by Ford®, Entune® by Toyota®, IntelliLink® by GMC®, etc.). In the illustrated example, the IHU includes the heads-up display 165 and a park assist engagement button 161. The IHU 160 displays the infotainment system on the windshield 111 via the HUD 165. The infotainment head unit 160 may additionally display the infotainment system on, for example, the center console display, and/or the instrument cluster display. A driver may input selection commands to, for example, park the vehicle 110 in a parking spot, determine a route to a waiting passenger, and select a leading vehicle via the IHU 160.

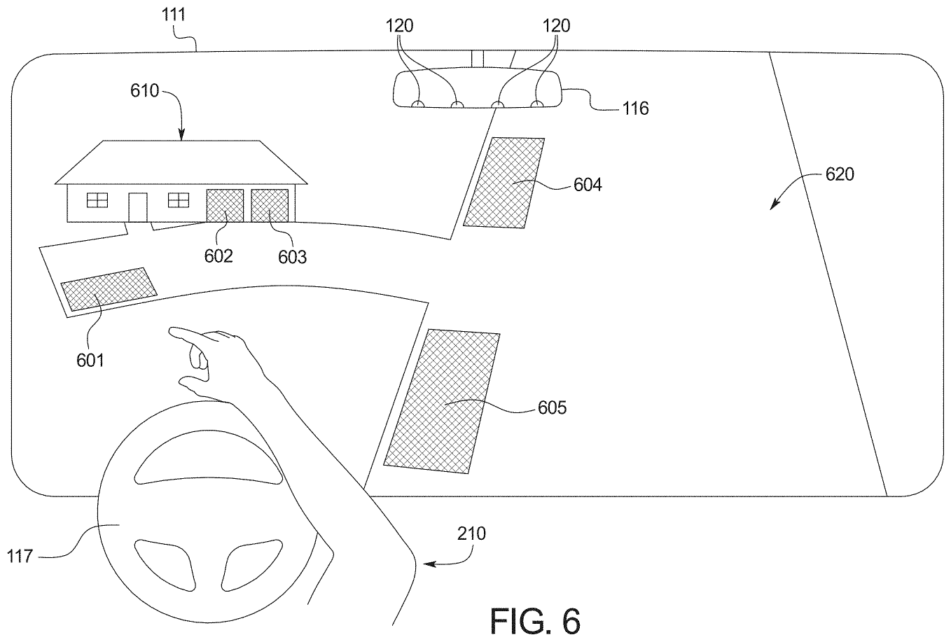

The heads-up display 165 casts (e.g., shines) images generated by the OBCP 150 onto the windshield 111. The images are reflected by the windshield 111 and are thus visible to the driver 210, as shown in FIGS. 6-9. The HUD 165 casts the images dynamically as the vehicle 110 moves. Thus, the images move (e.g., translate) over and across the windshield 111 and change size and shape from the perspective of the driver 210. The HUD 165 casts the images to dynamically overlay, highlight, and/or outline objects and/or features (e.g., parking spots, waiting passengers, leading vehicles, etc.) external to the vehicle 110.

In some examples, the HUD 165 displays images when the speed of the vehicle 110 is below a predetermined threshold. Further, in some examples, the HUD 165 ceases displaying images if the sensors 120 detect an object in the environment 100 that takes priority for the driver's 210 attention (e.g., a blind spot warning, a collision warning, etc.). Additionally, the HUD 165 may cease displaying and/or minimize images quickly based on commands from the driver 210 (e.g., via voice control, gestures, a touch screen, a button, etc.).

In some examples, the HUD 165 displays images only when the driver 210 requests a particular parking area to park in. Further, the HUD 165 limits the images displayed to those closest to a point of interest indicated by the driver 210 (e.g., within a predetermined radius of the vehicle 110).

In some examples, where the vehicle 110 is in an automated driving mode, the HUD 165 may display images while the vehicle 110 is traveling above the threshold speed and/or when the sensors 120 detect a high-priority object in the environment 100.

For example, the parking spot images 601, 602, 603, 604, 605 shown in FIG. 6 are superimposed over available parking spots near the vehicle 110. The HUD 165 dynamically casts the parking spot images 601, 602, 603, 604, 605, to increase in size and change position on the windshield 111 as the vehicle 110 approaches and maneuvers toward the spots and vice versa.

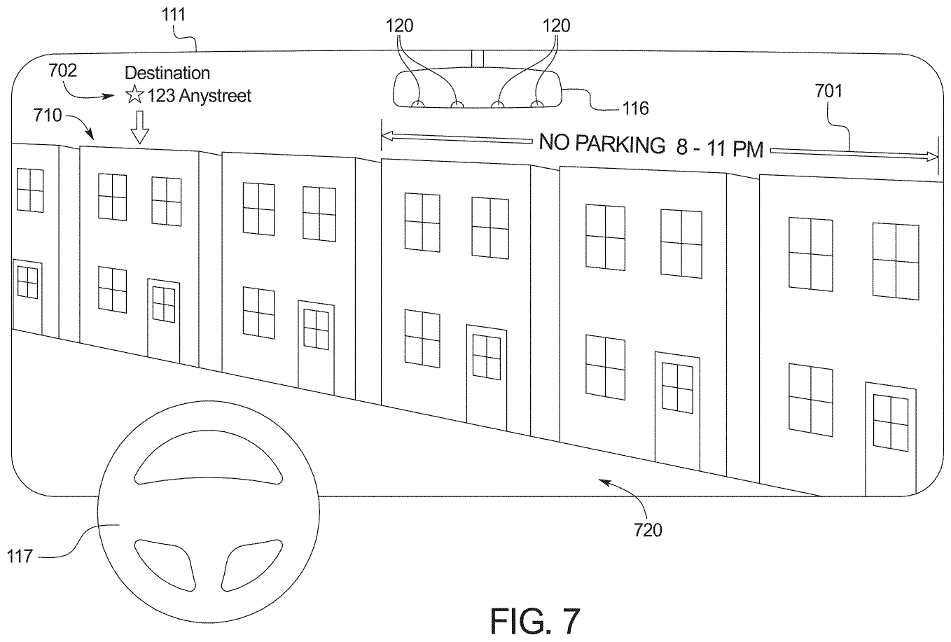

As another example, the parking restriction image 701 and the destination image 702 shown in FIG. 7 are superimposed over a stretch of parking spots under a parking restriction and a desired destination, respectively. The HUD 165 dynamically casts the parking restriction image 701 and the destination image 702 to increase in size and change position on the windshield 111 as the vehicle 110 approaches and maneuvers toward the restricted spots and the destination and vice versa.

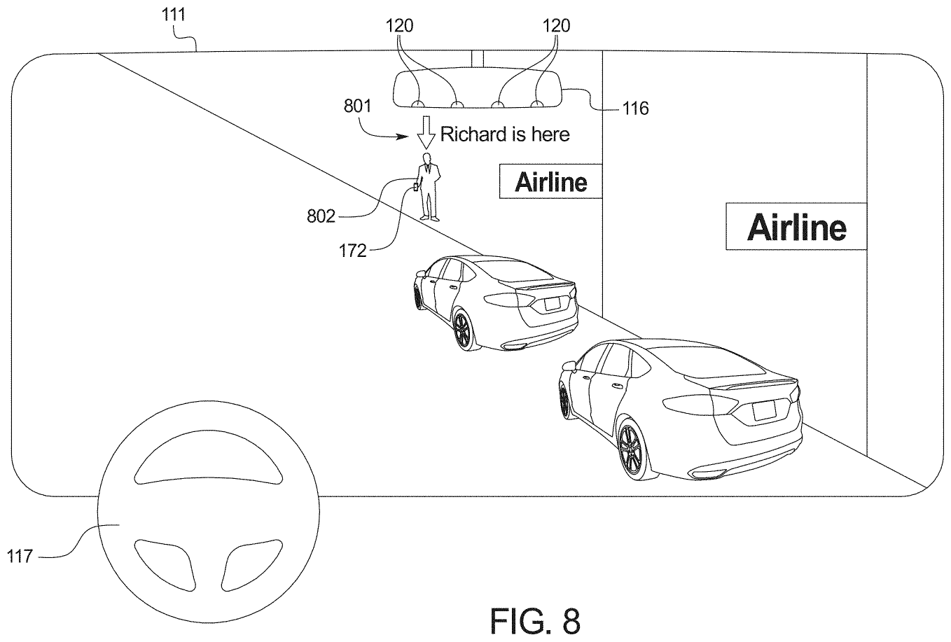

As another example, the waiting passenger image 801 shown in FIG. 8 is superimposed over a passenger 802 awaiting pickup. In the example of FIG. 8, the passenger 802 is at an airport. The HUD 165 dynamically casts the waiting passenger image 801 to increase in size and/or change position on the windshield 111 as the vehicle 110 approaches and maneuvers toward the passenger 802 and vice versa.

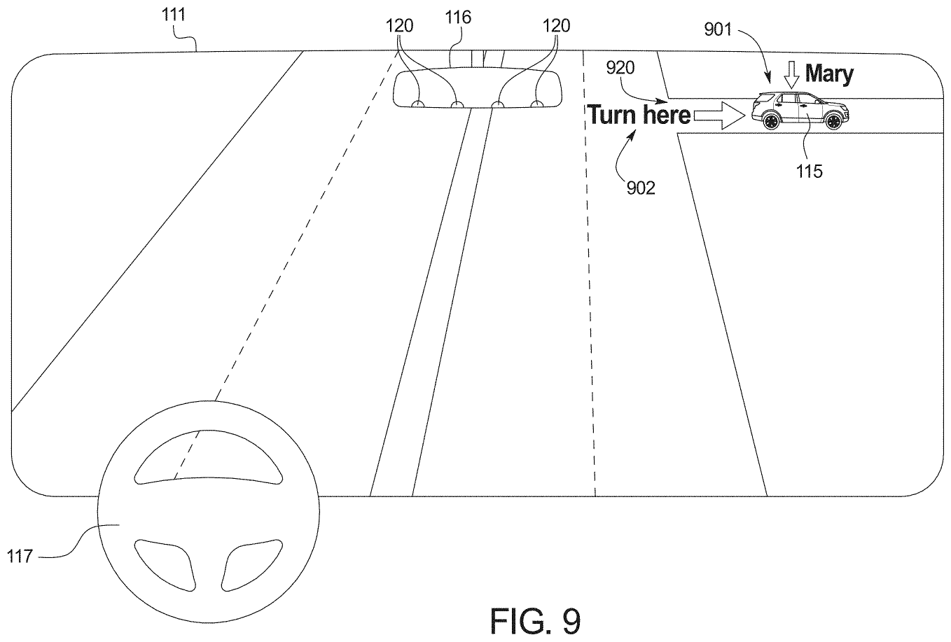

As another example, a lead vehicle image 901 and a navigation image 902 shown in FIG. 9 are displayed on the windshield 111. The lead vehicle image 901 is superimposed over the second vehicle 115 (e.g., driven by Mary), which is leading the first vehicle 110. The navigation image 902 is superimposed over the route taken by the second vehicle 115 to provide the driver with directions to follow the second vehicle 115. The HUD 165 dynamically casts the lead vehicle image 901 and the navigation image 902 to increase in size and/or change position on the windshield 111 as the vehicle 110 approaches and maneuvers relative to the second vehicle 115 and vice versa.

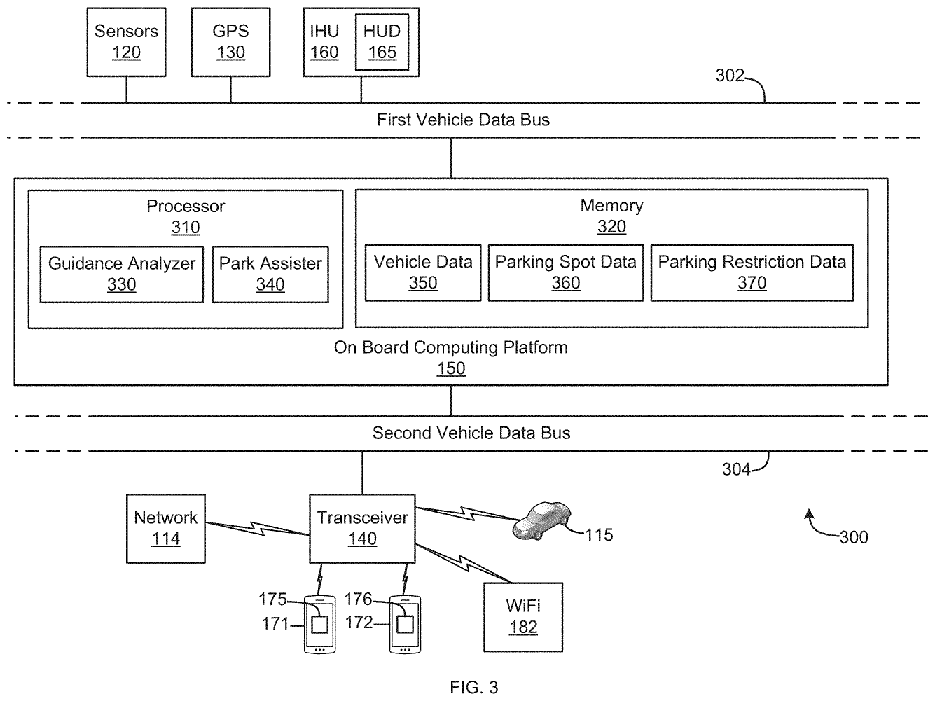

In some examples, the first and second mobile devices 171, 172 are smartphones. In some examples, one or more of the first and second mobile devices 171, 172 may also be, for example, a cellular telephone, a tablet, etc. The first and second mobile devices 171, 172 each include a transceiver to send and receive messages from the transceiver 140. The first mobile device 171 is carried by the driver 210 in the first vehicle 110. The first mobile device 171 presents these messages to the driver 210. The second mobile 172 presents these messages to a second party. As shown in FIG. 3, The first and second mobile devices 171, 172 each include a memory to respectively store first and second user identifiers 175, 176 (e.g., a name, biometric information, etc.).

In some examples, the second mobile device 172 is carried by a second driver in the second vehicle 115. In some examples, the second mobile device 172 is carried by a second party in or near a building (e.g., a home) where the local area wireless network 182 is located. In some examples, the second mobile device 172 is carried by a passenger awaiting pickup (e.g., the passenger 802). The second party, via the second mobile device 172, sends an inquiry demand to determine a location of the first vehicle 110, updates the first vehicle 110 with available parking spots, updates the first vehicle 110 with a location of the second mobile device 172, updates the first vehicle 110 with a destination, and/or updates the first vehicle 110 with a location of the second vehicle 115.

In some examples, the first mobile device 171 acts as a key to operate the first vehicle 110 (e.g., “phone-as-key”). In some examples, the second mobile device 172 acts as a key to operate the second vehicle 115.

The local computer 180 may be, for example, a desktop computer, a laptop, a tablet, etc. The local computer 180 is operated by a second party. The local computer 180 is located in or near a building (e.g., a home) where the local area wireless network 182 is located. The second party, via the local computer 180, sends an inquiry demand to determine a location of the first vehicle 110, updates the first vehicle 110 with available parking spots, updates the first vehicle 110 with a destination, and/or updates the first vehicle 110 with a location of the local computer 180. The local computer 180 sends and receives messages from the transceiver 140 via the network 114 and/or the local area wireless network 182.

In some examples, the central facility 190 is a traffic management office (e.g., a municipal building, a technology company building, etc.). The central facility 190 includes a database 192 of parking restrictions. The central facility sends and receives messages from the transceiver 140 via the network 114.

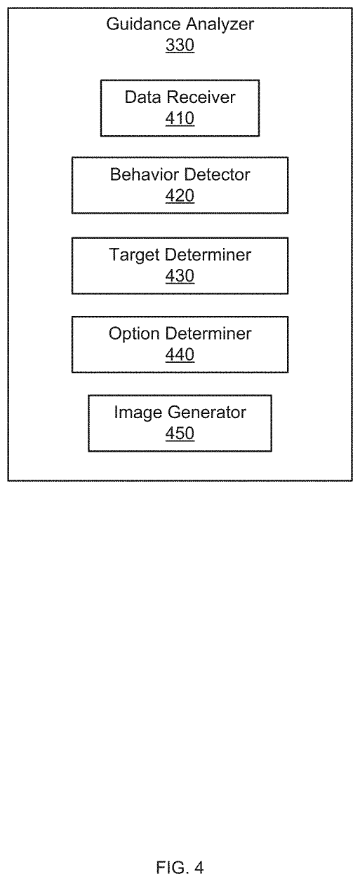

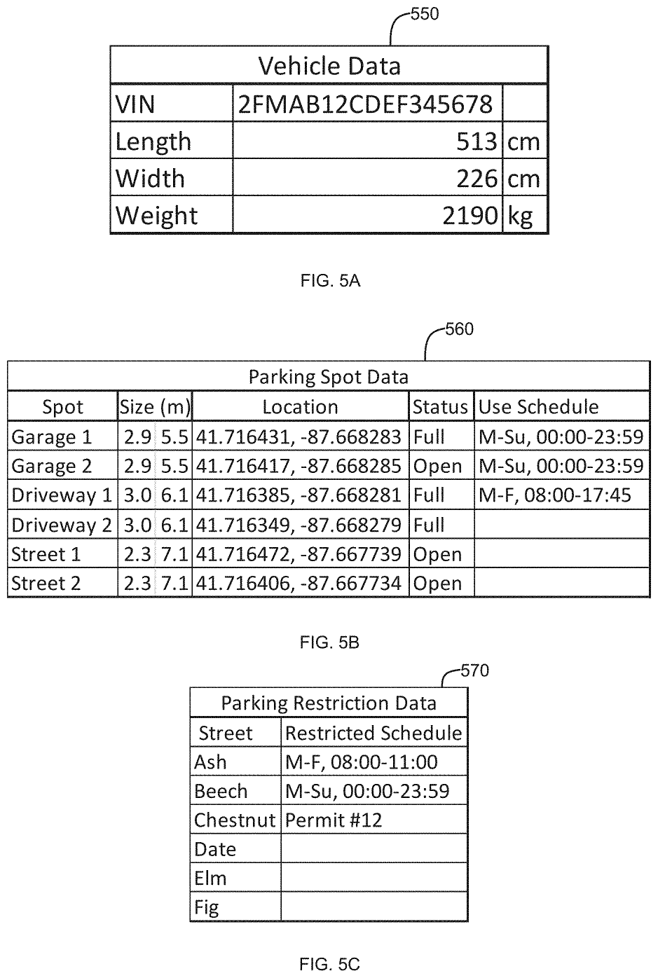

FIG. 3 is a block diagram of the electronic components 300 of the vehicle 110. FIG. 4 is a more detailed block diagram of a guidance analyzer 330. FIGS. 5A-C illustrate look-up tables 550, 560, 570 stored in a memory 320 of the electronic components 300. FIGS. 6-9 are schematic views of the HUD 165.

As shown in FIG. 3, the first vehicle data bus 302 communicatively couples the sensors 120, the GPS receiver 130, the IHU 160, the HUD 165, the OBCP 150, and other devices connected to the first vehicle data bus 402. In some examples, the first vehicle data bus 302 is implemented in accordance with the controller area network (CAN) bus protocol as defined by International Standards Organization (ISO) 11898-1. Alternatively, in some examples, the first vehicle data bus 302 may be a Media Oriented Systems Transport (MOST) bus, a CAN flexible data (CAN-FD) bus (ISO 11898-7), or an Ethernet bus. The second vehicle data bus 304 communicatively couples the OBCP 150 and the transceiver 140. As described above, the transceiver 140 is in wireless communication with the first and second mobile devices 171, 172, the network 114, the local area wireless network 182, and/or the second vehicle 115. The second vehicle data bus 304 may be a MOST bus, a CAN bus, a CAN-FD bus, or an Ethernet bus. In some examples, the OBCP 150 communicatively isolates the first vehicle data bus 302 and the second vehicle data bus 304 (e.g., via firewalls, message brokers, etc.). Alternatively, in some examples, the first vehicle data bus 302 and the second vehicle data bus 304 are the same data bus.

The OBCP 150 includes a processor or controller 310 and memory 320. In the illustrated example, the OBCP 150 is structured to include the guidance analyzer 330 and a park assister 340. Alternatively, in some examples, the guidance analyzer 330 and/or the park assister 340 may be incorporated into another electronic control unit (ECU) with its own processor 310 and memory 320.

In operation, the park assister 340 detects spaces large enough to park the vehicle 110 and determines a path for the vehicle 110 to follow to move into the space based on obstruction information from the sensors 120. The park assister 340 communicates with the steering system of the vehicle 110 to turn the wheels 112 of the vehicle 110 to steer the vehicle into the space. In some examples, the park assister 340 communicates with the powertrain of the vehicle 110 to control rotation of the wheels 112. Thus, park assister 340 effects a parking maneuver of the vehicle 110 into a space. In some examples, the driver 210 controls the rotation speed of the wheels 112 via the pedal assembly 118 while the park assister 340 controls the steering angle of the wheels 112. In some examples, the driver 210 controls the rotation speed of the wheels 112 remotely via the first mobile device 171 while the park assister 340 controls the steering angle of the wheels 112.

In operation, the guidance analyzer 330 detects driver behavior, determines targets, determines options, and generates images of the options for presentation to the driver 210. The guidance analyzer 330 makes these determinations based on surroundings information, selection information, and maneuvering information provided by the sensors 120.

The processor or controller 310 may be any suitable processing device or set of processing devices such as, but not limited to: a microprocessor, a microcontroller-based platform, a suitable integrated circuit, one or more field programmable gate arrays (FPGAs), and/or one or more application-specific integrated circuits (ASICs). The memory 320 may be volatile memory (e.g., RAM, which can include non-volatile RAM, magnetic RAM, ferroelectric RAM, and any other suitable forms); non-volatile memory (e.g., disk memory, FLASH memory, EPROMs, EEPROMs, non-volatile solid-state memory, etc.), unalterable memory (e.g., EPROMs), read-only memory, and/or high-capacity storage devices (e.g., hard drives, solid state drives, etc.). In some examples, the memory 320 includes multiple kinds of memory, particularly volatile memory and non-volatile memory.

The memory 320 is computer readable medium on which one or more sets of instructions, such as the software for operating the methods of the present disclosure can be embedded. The instructions may embody one or more of the methods or logic as described herein. In a particular embodiment, the instructions may reside completely, or at least partially, within any one or more of the memory 320, the computer readable medium, and/or within the processor 310 during execution of the instructions. The memory 320 stores vehicle data 350, parking spot data 360, and parking restriction data 370.

In some examples, the vehicle data 350 includes the look up table 550. As shown in FIG. 5A, the look up table 550 includes a vehicle identification number (VIN), a length of the vehicle 110, a width of the vehicle 110, and a weight of the vehicle 110. In other words, the vehicle data 350 includes dimensions, identifiers, and specifications of the vehicle 110. The vehicle data 350 may be used to present compatible parking spots to the driver 210. The vehicle data 350 is used to determine whether a potential parking spot is large enough and whether the surface (e.g., concrete, asphalt, soil, sand, etc.) can support the vehicle 110. The vehicle data 350 may be updated via the transceiver 140, the IHU 160, and/or an on board diagnostics (OBD) port of the vehicle 110.

In some examples, the parking spot data 360 includes the look-up table 560. As shown in FIG. 5B, the look-up table 560 includes parking spot identifiers (e.g., “Garage 1,” “Street 2”), parking spot dimensions (e.g., 2.9 meters by 5.5 meters), parking spot locations in GPS coordinates, parking spot statuses (e.g., “Full,” “Open”), and parking spot use schedules (e.g., Monday through Friday, from 8:00 AM until 5:45 PM). The parking spot data 360 is used to present available parking spots to the driver 210. For example, although parking spot “Garage 2” is open, its use schedule of Monday through Sunday from 12:00 AM to 11:59 PM indicates that parking spot “Garage 2” is not available for parking. In other words, in this example, parking spot “Garage 2” is always reserved (e.g., for a homeowner). As another example, parking spot “Driveway 1” is reserved Monday through Friday from 8:00 AM to 5:45 PM (e.g., for a commuter who rents parking spot “Driveway 1”). In other words, in this example, parking spot “Driveway 1” is reserved during working hours. The parking spot data 360 may be updated via the transceiver 140, the IHU 160, and/or the on board diagnostics (OBD) port of the vehicle 110.

In some examples, the parking restriction data 370 includes the look up table 570. As shown in FIG. 5C, the look up table 570 includes street identifiers (e.g., Ash, Beech, Chestnut, etc.) and restriction schedules (e.g., Monday through Friday from 8:00 AM until 11:00 AM). The restriction schedules are related to, for example, parking rules, street cleaning, construction, etc. The parking restriction data 370 is used to present unrestricted parking spots to the driver 210. For example, the parking restriction schedule for “Beech” of Monday through Sunday from 12:00 AM to 11:59 PM indicates that there is no parking anytime on “Beech.” As another example, parking is permitted on “Chestnut” only for vehicles bearing “Permit #12.” The parking restriction data 370 may be updated from the database 192 via the transceiver 140, the IHU 160, and/or an on board diagnostics (OBD) port of the vehicle 110. The parking restriction data 370 is a subset of the parking restriction data stored in the database 192. The subset forming the parking restriction data 370 is based on a location of the vehicle 110. For example, the parking restriction data 370 may include parking restrictions for streets within a predetermined radius of the vehicle 110, streets within a ZIP code where the vehicle is located, etc. In some examples, the parking restriction data 370 is updated dynamically as the vehicle 110 moves. In some examples, the parking restriction data 370 is updated based on an update demand from the vehicle 110 to the central facility 190.

The terms “non-transitory computer-readable medium” and “tangible computer-readable medium” should be understood to include a single medium or multiple media, such as a centralized or distributed database, and/or associated caches and servers that store one or more sets of instructions. The terms “non-transitory computer-readable medium” and “tangible computer-readable medium” also include any tangible medium that is capable of storing, encoding or carrying a set of instructions for execution by a processor or that cause a system to perform any one or more of the methods or operations disclosed herein. As used herein, the term “tangible computer readable medium” is expressly defined to include any type of computer readable storage device and/or storage disk and to exclude propagating signals.

As shown in FIG. 4, the guidance analyzer 330 includes a data receiver 410, a behavior detector 420, a target detector 430, an option determiner 440, and an image generator 450.

In operation, the data receiver 410 receives surroundings information, selection information, and maneuvering information sent by the sensors 120. The data receiver 410 receives commands made by the driver 210 via the IHU 160. Further, the data receiver 410 receives location data from the GPS receiver 130. Additionally, the data receiver 410 receives messages from the first mobile device 171, the second mobile device 172, the second vehicle 115, the central facility 190, and/or local computer 180. The messages include location updates, parking spot invitations, parking spot dimension updates, parking spot location updates, parking spot schedule updates, parking spot status updates, parking restriction updates, and destination updates, among others.

In operation, the behavior detector 420 detects behaviors performed by the driver 210 indicating that the driver 210 is looking for a parking spot. More specifically, the behavior detector 420 analyzes the information from the sensors 120 (e.g., pedal assembly 118 input types and frequencies, steering angles and rates, etc.) and/or commands from the IHU 160 to detect whether the driver 210 is attempting to park the vehicle 110. Parking spot-seeking behaviors include, for example, low vehicle speed (e.g., less than 10 miles per hour), repeated depressions of brake pedal 118b, depression of the park assist engagement button 161, etc.

In operation, the target detector 430 detects navigation targets sought by the driver 210. Navigation targets include parking spaces, leading vehicles, passengers waiting for pick up, and destinations, among others.

More specifically, in some examples, the target detector 430 accesses the parking spot data 360 and based on the location of the vehicle 110 indicated by the location data. Thus, the target detector 430 detects parking spots within a predetermined radius of the vehicle 110 and/or related to a destination. For example, as shown in FIG. 6, the target detector 430 detects the parking spots related to the house 610 and in the street 620 highlighted by parking spot images 601, 602, 603, 604, 605.

Additionally, in some examples, the target detector 430 accesses the parking restriction data 370 based on the location of the vehicle 110 indicated by the location data. Thus, the target detector 430 detects restricted and unrestricted parking spots along a street along which the vehicle 110 is driving. For example, as shown in FIG. 7, the target detector 430 detects the destination 710 highlighted by the destination image 702 and the stretch of street 720 under a parking restriction highlighted by the parking restriction image 701.

Further, the target detector 430 detects beacon signals from the second mobile device 172 and/or the second vehicle 115. The target detector 430 also detects roadway features based on the location data from the GPS receiver 130. For example, as shown in FIG. 8, the target detector 430 detects a beacon signal from the second mobile device 172, which is carried by the waiting passenger 802. In another example, as shown in FIG. 9, the target detector 430 detects a beacon signal from the leading second vehicle 115. In such an example, the target detector 430 also detects the turn 920 taken by the second vehicle 115 and highlighted by the navigation image 902.

In operation, the option determiner 440 determines which of the navigation targets detected by the target detector 430 are suitable for presentation to the driver 210. In other words, the option determiner 440 selects all or a subset of the detected targets to provide to the driver 210 as navigation options. Thus, navigation options include available parking spaces, leading vehicles, passengers waiting for pick up, and destinations, among others. Additionally, the option determiner 440 determines messages for presentation to the driver 210 (e.g., regarding parking restrictions, destination locations, parking spot schedules, etc.).

More specifically, in some examples, the option determiner 440 accesses the vehicle data 350 and compares the vehicle data 350 to the parking spot data 360 of detected potential parking spots. In other words, the option determiner 440 determines whether the vehicle 110 can fit in the detected parking spots, whether the parking spot is reserved, whether the detected parking spot is full, a remaining time until the parking spot is reserved, a remaining time until the parking spot is unreserved. For example, where a second party (e.g., a homeowner of house 610) has invited the driver 210 to park in a particular parking spot, the option determiner 440 determines whether the vehicle 110 will fit into the particular parking spot. For example, as shown in FIG. 6, the option determiner 440 determines that the vehicle 110 will fit in the unreserved parking spots related to the house 610 and in the street 620 highlighted by parking spot images 601, 602, 603, 604, 605.

Additionally, in some examples, the option determiner 440 sends the vehicle data 350 to the second party before arriving at the second party destination. Thus, the second party is prompted to compare the vehicle data 350 to the parking spot data 360 via the local computer 180 and/or the second mobile device 172 to invite the driver 210 to park in a spot suitable for the vehicle 110. For example, where the driver 210 has recently traded an old vehicle for a new larger vehicle 110, the option determiner 440 alerts the second party that the driver 210 will need a larger spot than previously used.

Additionally, in some examples, the option determiner 440 sends the user identifier 175 to the second party before arriving at the second party destination. Thus, the second party is prompted to compare the user identifier 175 to the parking spot data 360 via the local computer 180 and/or the second mobile device 172 to invite the driver 210 to park in a spot suitable for the driver 210. For example, where the driver 210 is elderly or disabled, the second party may invite the driver 210 to park in a spot closest to or near the house 610, as shown in FIG. 6.

Additionally, in some examples, the option determiner 440 accesses the parking restriction data 370 and compares the parking restriction data 370 to the detected potential parking spots. In other words, the option determiner 440 determines whether the vehicle 110 is permitted to park in the detected parking spots. For example, as shown in FIG. 7, the option determiner 440 determines that the vehicle 110 is not permitted to park along the stretch of street 720 highlighted by the parking restriction image 701. In other words, despite there being physical space for the vehicle 110 to park in the street 720, the option determiner 440 determines that parking in the street 720 is not an available navigation option for the driver 210.

Additionally, in some examples, the option determiner 440 tracks beacon signals from the second mobile device 172 and/or the second vehicle 115. For example, as shown in FIG. 8, the option determiner 440 determines the location of the beacon signal from the second mobile device 172, which is carried by the waiting passenger 802. In another example, as shown in FIG. 9, the option determiner 440 determines the location of the beacon signal from the leading second vehicle 115. In such an example, the option determiner 440 also determines a distance remaining to the turn 920 taken by the second vehicle 115 and highlighted by the navigation image 902.

In operation, the image generator 450 generates images of the navigation options and navigation messages for display on the windshield 111 via the HUD 165. For example, as shown in FIGS. 6-9, the image generator 450 generates parking spot images 601, 602, 603, 604, 605, parking restriction image 701, the destination image 702, waiting passenger image 801, lead vehicle image 901, the navigation image 902, etc.

Additionally, in some examples, the image generator 450 generates images of the navigation options and navigation messages for display via a display of the IHU 160. Further, in some examples, the image generator 450 generates images of the navigation options and navigation messages for display via a display of the first mobile device 171.

In operation, as explained above, the image generator 450 generates the images dynamically to adjust in size and position across the windshield 111, the IHU 160 display, and/or the first mobile device 171 display as the vehicle 110 moves relative to the navigation options.

Referring to FIG. 6, in some examples, the driver 210 selects one or more navigation options (e.g., the parking spot images 601, 602, 603, 604, 605) by gesturing with his or her arm and/or hand. In other words, to select one of the parking spots, the driver 210 points at the respective parking spot images (e.g., parking spot image 601). More specifically, the sensors 120 detect the gesturing movements of the driver's 210 hand and/or arm.

Additionally, in some examples, the driver 210 selects one or more navigation options by giving voice commands (e.g., speaking). More specifically, the sensors 120 (e.g., a microphone) detect the vibrations of the driver's 210 voice.

Additionally, in some examples, the driver 210 selects one or more navigation option by touching a touchscreen and/or button of the IHU 160. Further, in some examples, the driver 210 selects one or more navigation options by touching a touchscreen of the first mobile device 171.

Referring back to FIGS. 3 and 4, in operation, the behavior detector 420 determines which of the navigation options is selected based on the driver's 210 gesture, voice command, and/or touch input. In some examples, where the selected navigation option is a parking spot, the behavior detector 420 forwards the selected navigation option to the park assister 340. The park assister 340 maneuvers the vehicle 110 into the parking spot as described above.

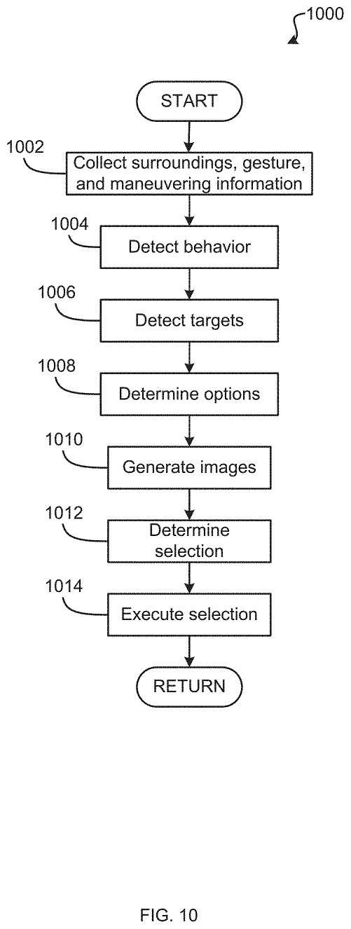

FIG. 10 is a flowchart of a method 1000 to display navigation options via the IHU 160 and/or the first mobile device 171 of FIGS. 1-2, which may be implemented by the electronic components of FIG. 3. The flowchart of FIG. 10 is representative of machine readable instructions stored in memory (such as the memory 320 of FIG. 3) that comprise one or more programs that, when executed by a processor (such as the processor 310 of FIG. 3), cause the vehicle 110 to implement the example guidance analyzer 330 of FIGS. 3 and 4. Further, although the example program(s) is/are described with reference to the flowchart illustrated in FIG. 10, many other methods of implementing the guidance analyzer 330 may alternatively be used. For example, the order of execution of the blocks may be changed, and/or some of the blocks described may be changed, eliminated, or combined.

Initially, at block 1002, the data receiver 410 collects surroundings, gesture, and maneuvering information. As discussed above, the data receiver 410 receives the surroundings, gesture, and maneuvering information from the sensors 120.

At block 1004, the behavior detector 420 detects behaviors indicating that the driver 210 is looking for a parking spot. As discussed above, the behavior detector 420 analyzes information from the sensors 120 and/or commands from the IHU 160 to detect whether the driver 210 is attempting to park the vehicle 110.

At block 1006, the target detector 430 detects navigation targets sought by the driver 210. As discussed above, the target detector 430 compares location data to the parking spot data 360 and/or the parking restriction data 370 to detect available and restricted parking spots. Also as discussed above, the target detector 430 detects beacon signals from the second mobile device 172 and/or the second vehicle 115 and roadway features based on the location data.

At block 1008, the option determiner 440 determines which of the navigation targets detected by the target detector 430 are suitable for presentation to the driver 210. As discussed above, the option determiner 440 compares the vehicle data 350 to the parking spot data 360 and/or the parking restriction data 370 of detected potential parking spots.

At block 1010, the image generator 450 generates images of the navigation options and navigation messages. As discussed above, the image generator 450 generates the images dynamically to change in size and position across the windshield 111, the IHU 160, and/or the first mobile device 171.

At block 1012, the behavior detector 420 determines which of the navigation options is selected. As discussed, above the behavior detector 420 determines the selection based on one or more of gestures and voice commands sensed by the sensors 120 and touch inputs made via the IHU 160 and/or the first mobile device 171.

At block 1014, the park assister 340 and/or image generator 450 execute the selection. As discussed above, the park assister 340 maneuvers the vehicle 110 into a selected parking spot. In some examples, the image generator 450 dynamically displays the selected navigation option. The method 1000 then returns to block 1002.

In this application, the use of the disjunctive is intended to include the conjunctive. The use of definite or indefinite articles is not intended to indicate cardinality. In particular, a reference to “the” object or “a” and “an” object is intended to denote also one of a possible plurality of such objects. Further, the conjunction “or” may be used to convey features that are simultaneously present instead of mutually exclusive alternatives. In other words, the conjunction “or” should be understood to include “and/or”. The terms “includes,” “including,” and “include” are inclusive and have the same scope as “comprises,” “comprising,” and “comprise” respectively.

From the foregoing, it should be appreciated that the above disclosed apparatus and methods may aid drivers by integrating communication technologies, displays, and vehicle states to provide navigation options. By providing navigation options, drivers may more easily find available parking spots, pick up waiting passengers, and/or follow a leading vehicle. Thus, displayed navigation option may save drivers time and associated fuel. In other words, the above disclosed apparatus and methods may alleviate everyday navigation difficulties. It should also be appreciated that the disclosed apparatus and methods provide a specific solution—providing drivers with displayed navigation options—to specific problems—difficulty in finding an adequately sized parking spot, finding an unrestricted parking spot, finding waiting passengers, and following a leading vehicle. Further, the disclosed apparatus and methods provide an improvement to computer-related technology by increasing functionality of a processor to locate navigation targets and determine which of the navigation targets to display to a driver based on location data, vehicle data, second party parking spot data, and/or parking restriction data.

As used here, the terms “module” and “unit” refer to hardware with circuitry to provide communication, control and/or monitoring capabilities, often in conjunction with sensors. “Modules” and “units” may also include firmware that executes on the circuitry.

The above-described embodiments, and particularly any “preferred” embodiments, are possible examples of implementations and merely set forth for a clear understanding of the principles of the invention. Many variations and modifications may be made to the above-described embodiment(s) without substantially departing from the spirit and principles of the techniques described herein. All modifications are intended to be included herein within the scope of this disclosure and protected by the following claims.

What is claimed is:

1. A vehicle comprising:
a global positioning system (GPS) receiver to receive location data;
a transceiver to receive second party information; and
a processor and memory in communication with the GPS receiver and the transceiver and configured to:
determine a navigation option using the location data and the second party information; and
dynamically display an image of the navigation option via a display.

2. The vehicle of claim 1, further comprising an infotainment head unit (IHU), wherein the display is included in the IHU.

3. The vehicle of claim 2, further comprising a windshield, wherein the IHU includes a heads-up display (HUD) to cast the image of the navigation option on the windshield.

4. The vehicle of claim 1, wherein, to dynamically display the image of the navigation option, the processor is configured to adjust the image in size and position on the display as the vehicle moves relative to the navigation option.

5. The vehicle of claim 1, further comprising sensors in communication with the processor to generate selection information from a driver input, wherein the processor is configured to select the navigation option based on the selection information.

6. The vehicle of claim 5, wherein the driver input is one or more of a gesture made by a driver, a button in communication with the sensors being pushed by the driver, or a touchscreen in communication with the sensors being touched by the driver.

7. The vehicle of claim 1, wherein the second party information includes one or more of parking spot data, parking restriction data, or a beacon signal.

8. The vehicle of claim 1, further comprising wheels, wherein the navigation option is an available parking spot and the processor is configured to control the wheels to maneuver the vehicle into the available parking spot.

9. A method comprising:
determining, with a processor, a navigation option for a driver of a vehicle using location data received via a global positioning system receiver and second party information received via a transceiver; and
dynamically displaying an image of the navigation option via a display.

10. The method of claim 9, wherein the display is included in an infotainment head unit (IHU) of the vehicle.

11. The method of claim 10, wherein the IHU includes a heads-up display (HUD) to cast the image of the navigation option on a windshield of the vehicle.

12. The method of claim 9, wherein dynamically displaying the image of the navigation option comprises adjusting, with the processor, the image in size and position on the display as the vehicle moves relative to the navigation option.

13. The method of claim 9, further comprising selecting, with the processor, the navigation option using selection information generated by sensors based on a driver input.

14. The method of claim 13, wherein the driver input is on one or more of a gesture made by the driver, a button push, or a touchscreen touch.

15. The method of claim 9, wherein the second party information includes one or more of parking spot data, parking restriction data, or a beacon signal.

16. The method of claim 9, wherein the navigation option is an available parking spot and further comprising, controlling, with the processor, wheels of the vehicle to maneuver the vehicle into the available parking spot.

17. A system comprising:
a network;
a mobile device in communication with the network;
a central facility in communication with the network; and
a vehicle comprising:
a transceiver in communication with the network to receive second party information from one or more of the mobile device and the central facility;
a global positioning system (GPS) receiver in communication with a GPS satellite to generate location data;
an infotainment head unit (IHU); and
a processor and memory in communication with the transceiver, the GPS receiver, and the IHU and configured to:
determine a navigation option using the location data and the second party information; and
dynamically display an image of the navigation option via the IHU.

18. The system of claim 17, wherein the vehicle further comprises a windshield and the IHU includes a heads-up display (HUD) to cast the image of the navigation option on the windshield.

19. The system of claim 17, wherein to dynamically display the image of the navigation option, the processor is configured to adjust the image in size and position on a display controlled by the IHU as the vehicle moves relative to the navigation option.

20. The system of claim 17, wherein
the vehicle further comprises sensors to generate selection information based on one or more of a gesture made by a driver, a button of the IHU being pushed by the driver, or a touchscreen of the IHU being touched by the driver, and
the processor is configured to select the navigation option based on the selection information.
